(19) United States
(12) Patent Application Publication
(10) Pub. No.: US 2026/0366696 A1
(43) Pub. Date: Nov. 19, 2026

(54) INFLATABLE LIGHTING DEVICE

(71) Applicant: Ztarx Corporation Limited, Shenzhen (CN)

(72) Inventor: Songping Chen, Shenzhen (CN)

(21) Appl. No.: 19/740,308

(22) Filed: Jul. 14, 2026

(30) Foreign Application Priority Data
May 15, 2025 (CN) 202520962455.5

(51) Int. Cl. F21V 3/02; F21S 4/24; F21V 21/096; F21V 23/00; F21V 23/02; F21V 23/06; F21V 31/00

(52) U.S. Cl. CPC F21V 3/026; F21S 4/24; F21V 21/096; F21V 23/002; F21V 23/023; F21V 23/06; F21V 31/005

(57) ABSTRACT

An inflatable lighting device includes: a cover, an illuminating body, and a support member. The cover defines an inflatable cavity therein. Gas is capable of being inflated into or deflated out of the inflatable cavity, and the cover has a placement end. The illuminating body is foldable and mounted in the inflatable cavity. The support member is mounted on the placement end of the cover and configured to support the cover. The support member may be arranged to support the cover on the placement surface such as the ground or the table top, allowing the inflatable lighting device to be used in an upright position.

### CROSS REFERENCE TO RELATED APPLICATIONS

The present application claims the priority of the Chinese patent application No. 202520962455.5, filed on May 15, 2025. The disclosure of the aforementioned application is incorporated by reference herein in its entirety.

### TECHNICAL FIELD

The present disclosure relates to the technical field of lighting devices, and particularly to an inflatable lighting device.

### BACKGROUND

A method of how to use an inflatable lighting device may be limited. The inflatable lighting device may not be used by being directly placed on a placement surface, such as a table top or a ground. The inflatable lighting device may not be adapted to some scenarios.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, an inflatable lighting device includes: a cover, an illuminating body, and a support member. The cover defines an inflatable cavity therein. Gas is capable of being inflated into or deflated out of the inflatable cavity, and the cover has a placement end. The illuminating body is foldable and mounted in the inflatable cavity. The support member is mounted on the placement end of the cover and configured to support the cover.

### BRIEF DESCRIPTION OF THE DRAWINGS

Illustrative embodiments of the present disclosure are described in detail below with reference to the attached drawing figures.

FIG. 1 is a first overall schematic view of an inflatable lighting device of an embodiment of the present disclosure.

FIG. 2 is a second overall schematic view of the inflatable lighting device of an embodiment of the present disclosure.

FIG. 3 is a schematic view showing a positional relationship of a support member, a cover, and an illuminating body according to an embodiment of the present disclosure.

FIG. 4 is a schematic view showing a vertical projection of a gravitational center of the inflatable lighting device falling within a vertical projection of the support member according to an embodiment of the present disclosure.

FIG. 5 is a vertical cross-sectional view of the inflatable lighting device according to an embodiment of the present disclosure.

FIG. 6 is an enlarged view of a portion A in FIG. 5.

FIG. 7 is a schematic view showing the illuminating body being a flexible light strip according to an embodiment of the present disclosure.

FIG. 8 is a schematic view showing the illuminating body including a plurality of light panels according to an embodiment of the present disclosure.

FIG. 9 is a schematic structural view of the support member according to an embodiment of the present disclosure, where the support member includes a housing and a lid.

FIG. 10 is a schematic structural view of the housing according to an embodiment of the present disclosure.

FIG. 11 is a schematic view of a shape of the cover according to another embodiment of the present disclosure.

FIG. 12 is a schematic view of the shape of the cover according to still another embodiment of the present disclosure.

FIG. 13 is a schematic view showing a handle portion arranged on the support member according to still another embodiment of the present disclosure.

FIG. 14 is a schematic diagram of an embodiment, showing a lower support member integrally arranged on the support member according to an embodiment of the present disclosure

FIG. 15 is a schematic view showing the lower support member detachably connected to the lid according to still another embodiment of the present disclosure.

FIG. 16 is a schematic view showing an extendable and retractable rod member arranged on the lower support member according to still another embodiment of the present disclosure.

Reference numerals in the drawings:
10—cover; 100—inflatable cavity; 101—placement end; 102—inner wall of the inflatable cavity; 103—opposite end;
20—illuminating body; 201—flexible light strip; 202—light panel; 203—connection wire;
30—support member; 31—housing; 32—lid; 33—lower support member; 34—handle portion; 301—support surface; 302—connection portion; 303—wire hole; 304—sealing adhesive; 305—power supply cavity; 311—opening; 321—bottom surface of the lid; 322—recessed groove; 323—insertion slot; 331—insertion protrusion;
40—mounting cover; 400—receiving cavity;
50—electrical connection component;
60—power supply component;
70—hanging element;
80—strap;
90—magnetic attraction member;
1000—gravitational center of the inflatable lighting device; 3000—vertical projection of the support member.

### DETAILED DESCRIPTION

The following describes some non-limiting exemplary embodiments of the disclosure with reference to the accompanying drawings. The embodiments described are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

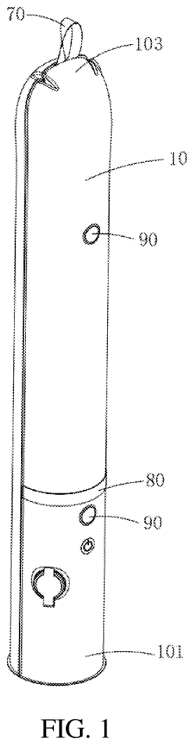

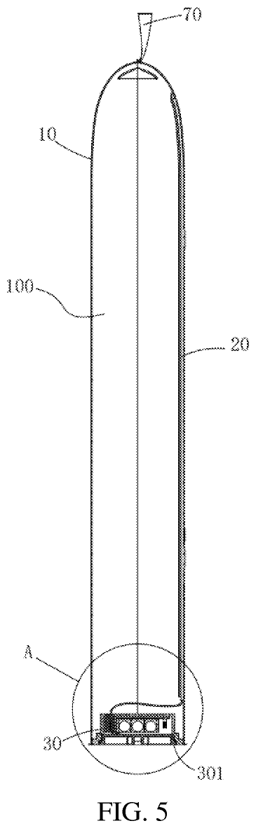

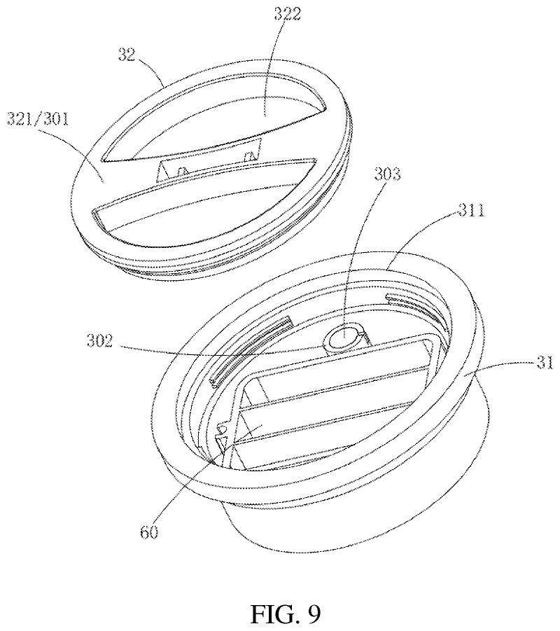

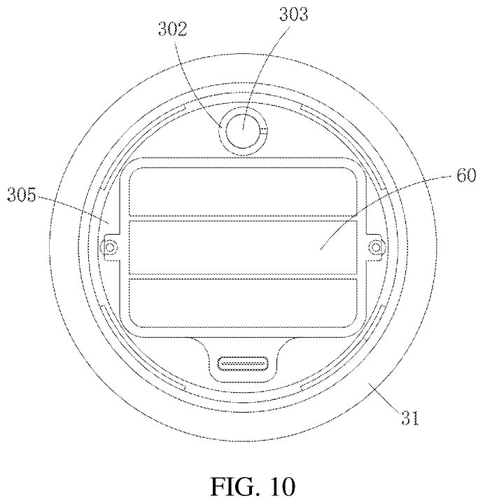

As shown in FIGS. 1 to 16, the present disclosure may provide an inflatable lighting device, including a cover 10, an illuminating body 20, and a support member 30. An inflatable cavity 100 may be defined in the cover 10. The cover 10 may be made of a soft material. When gas is inflated into the inflatable cavity 100, the cover 10 may expand and may be unfolded. When the gas in the inflatable cavity 100 is discharged, the cover 10 may be flat and may be folded or rolled, such that the cover 10 may be easily stored. In addition, an inflation-deflation component may be mounted on the cover 10 for inflating or deflating the inflatable cavity 100.

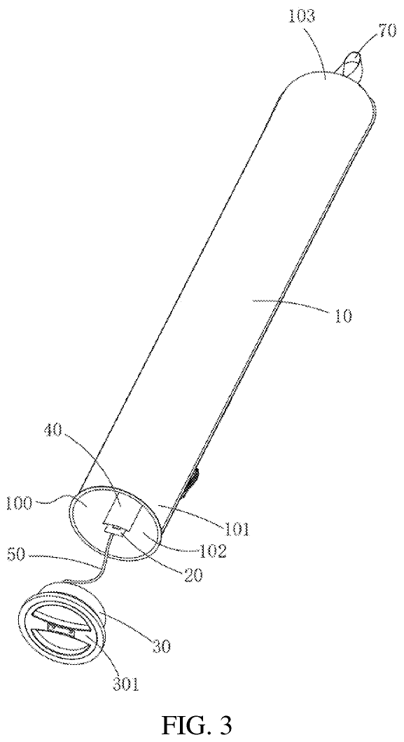

As shown in FIG. 3, the illuminating body 20 may be mounted in the inflatable cavity 100. The illuminating body 20 may be foldably arranged, such that the illuminating body 20 may expand as the cover 10 is unfolded or may be folded as the cover 10 is folded.

The cover 10 may have a placement end 101, and the support member 30 may be mounted at the placement end 101 of the cover 10. The support member 30 may be configured to abut against a placement surface, enabling the cover 10 to be placed on the placement surface. It should be noted that the illuminating body 20 may be entirely mounted inside the cover 10, rather than being directly mounted on the support member 30.

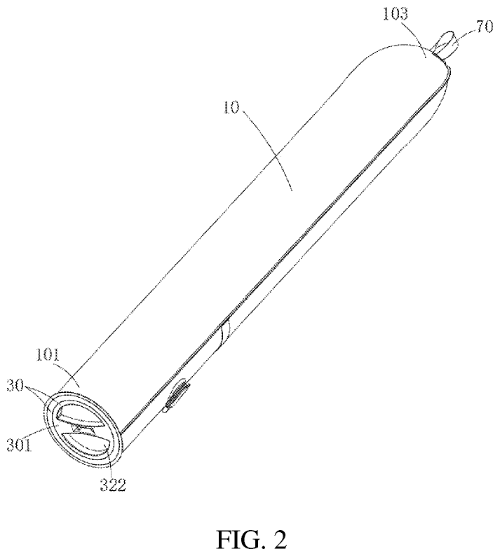

In some embodiments, as shown in FIG. 2, a surface of the support member 30 facing away from the cover 10 may be a support surface 301, and the support surface 301 may be a flat surface, such that the support surface 301 may directly abut against the placement surface such as a ground or a table top. That is, the support surface 301 abutting against the ground or the table top may be equivalent to the cover 10 being placed on the ground or the table top for use.

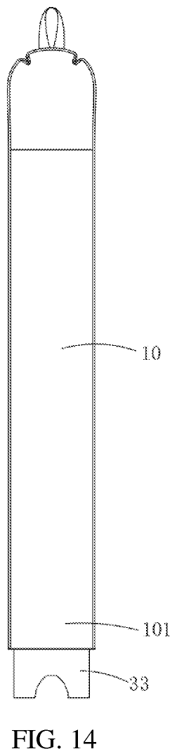

In other embodiments, as shown in FIGS. 14, 15, and 16, a side of the support member 30 facing away from the cover 10 may be arranged with a lower support member 33, and the lower support member 33 may abut against the placement surface.

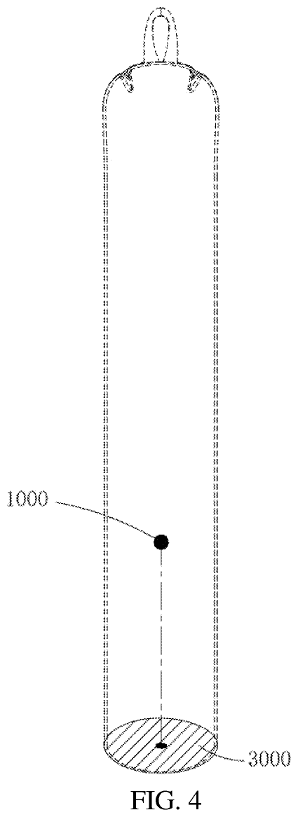

Further, as shown in FIG. 4, in order to ensure that the inflatable lighting device is stable and reliable after being placed, when the support member 30 is placed on the placement surface, a vertical projection of a gravitational center 1000 of the inflatable lighting device onto the placement surface may fall within a vertical projection 3000 of the support member 30 onto the placement surface, such that the inflatable lighting device may be prevented from falling over after being placed. In some embodiments, when the placement surface is horizontal, a gravitational center of the support member 30 and a gravitational center of the cover 10 may be aligned on one vertical line.

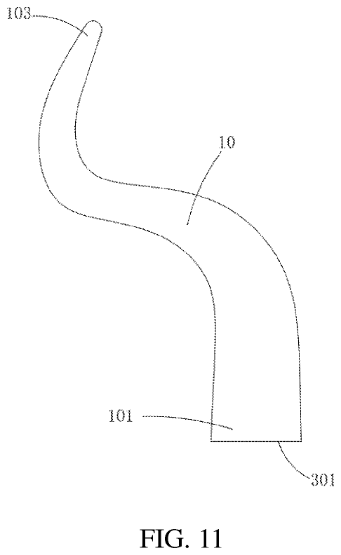

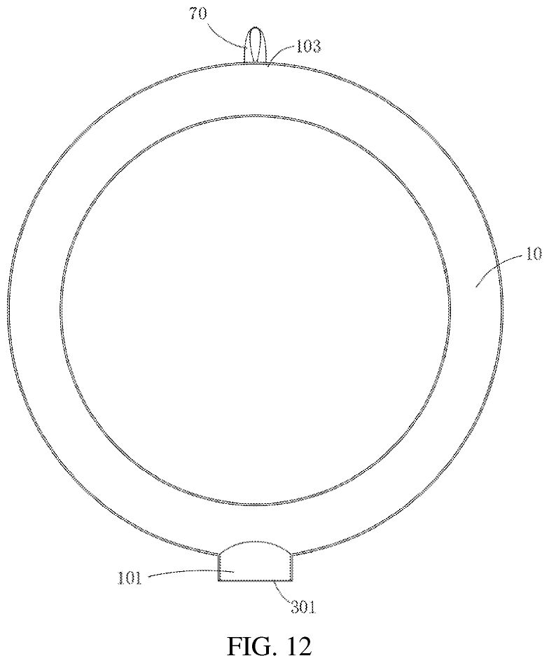

A shape of the cover 10 may not be limited herein. For example, the cover 10 may be elongated, annular, letter-shaped, symbol-shaped, or in any other regular or irregular shape, and so on. The cover shown in FIG. 11 may be a curved strip. The cover shown in FIG. 12 may be annular. The cover 10 may be formed by two flexible sheets being hot-pressed to each other. One of the two flexible sheets may be non-light-transmissive, and the other one of the two flexible sheets may be light-transmissive. Alternatively, the two flexible sheets may both be light-transmissive. In some embodiments, the cover 10 may be a tubular member formed by one sheet of a TPU material being rolled.

In the present embodiment, the cover 10 may be columnar as an example. As shown in FIGS. 1 and 2, the cover 10 may further include an opposite end 103 opposite to the placement end 101. A length of the cover 10 may extend from the placement end 101 to the opposite end 103. The surface of the support member 30 facing away from the opposite end 103 may be the support surface 301. The placement end 101 may serve as a bottom end of the cover 10, and the opposite end 103 may serve as a top end of the cover 10. During use, the inflatable cavity 100 may be first inflated, such that the cover 10 may expand and may be shaped to be columnar. The cover 10 may be vertically placed on the placement surface such as the ground or the table top to be used properly. In some embodiments, a magnetic member may be arranged on the support member 30, and the magnetic member may enable the support member 30 be attracted to a ferrous object for use. In this way, the cover 10 may be used on a non-horizontal surface. Therefore, a usage manner of the inflatable lighting device may be expanded, the inflatable lighting device may be used by being placed horizontally and by being inverted-hung. The magnetic member is not shown in the drawings.

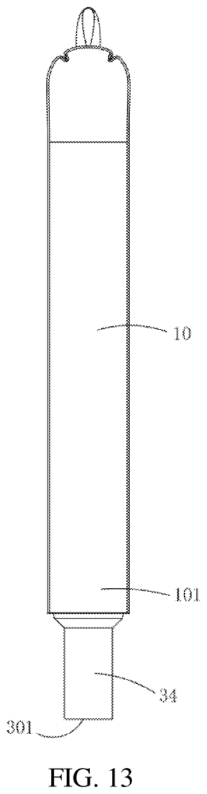

In order to enable the inflatable lighting device to be more aesthetically pleasing, in some embodiments, as shown in FIG. 2, at least part of the support member 30 may be received within the inflatable cavity 100, and the support surface 301 may be exposed from the bottom end of the cover 10. The support member 30 and the cover 10 may be sealingly connected to each other, for example, the cover 10 may be mounted to an outer wall surface of the support member 30 by welding or adhesive bonding. In other embodiments, as shown in FIG. 13, at least part of the support member 30 may be received within the inflatable cavity 100, and the support member 30 may have a handle portion 34 disposed outside the cover 10. The support surface 301 may be a bottom surface of the handle portion 34. The handle portion 34 may be gripped by a user to carry the inflatable lighting device, and therefore, an additional usage method of the inflatable lighting device may be provided. In another embodiment, the support member 30 may be entirely arranged inside the cover 10, i.e., the support member 30 may be entirely fixed to an inner wall 102 of the inflatable cavity 100, and the support member 30 may abut against the cover 10. An outer wall of the cover 10 may form a flat surface corresponding to the support surface 301, and the flat surface of the outer wall of the cover 10 may abut against the ground or the table top. In this way, the same effect as the previous embodiment may be achieved. The present embodiment is not shown in the drawings.

In some embodiments, the illuminating body 20 may be distributed along a length direction of the cover 10 or along the shape of the cover 10.

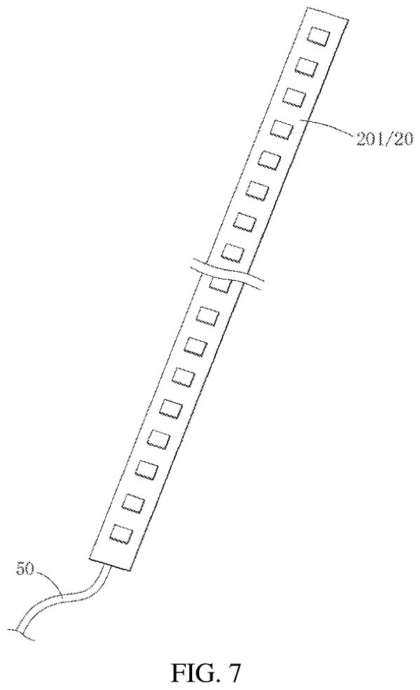

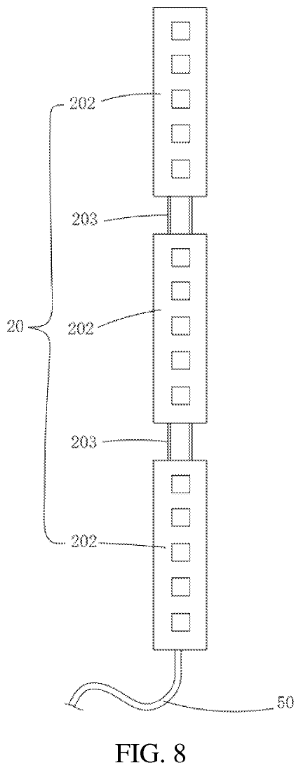

In regard to the foldable illuminating body 20, as shown in FIG. 7, in some embodiments, the illuminating body 20 may be configured as a flexible light strip 201. The flexible light strip 201 may be entirely attached to the inner wall 102 of the inflatable cavity 100, such that the flexible light strip 201 to may be folded/rolled as the cover 10 being folded/rolled; and when the cover 10 is inflated and expands, the flexible light strip 201 may be shaped as the cover 10 being shaped In regard to the foldable illuminating body 20, as shown in FIG. 8, in other embodiments, the illuminating body 20 may include a plurality of light panels 202, and the plurality of light panels 202 may be flexibly connected to each other, such that a relative position between any two adjacent light panels 202 may be changeable. For example, when the plurality of light panels 202 are arranged on the elongated cover 10, the plurality of light panels 202 may be sequentially connected to each other by a flexible connection wire 203. Therefore, when the relative position of the two adjacent light panels 202 changes, the connection wire 203 may be deformed accordingly and may always maintain electrical connection between the two adjacent light panels 202. In this way, any two adjacent light panels 202 may flip toward each other, and therefore, the illuminating body 20 may be folded. Furthermore, each of the plurality of light panels 202 may be made of a rigid or soft material, and the plurality of light panels 202 may be attached and fixed to the inner wall 102 of the inflatable cavity 100. When the gas inside the cover 10 is discharged, the cover 10 may be bent and folded at a flexible connected position between the adjacent light panels 202.

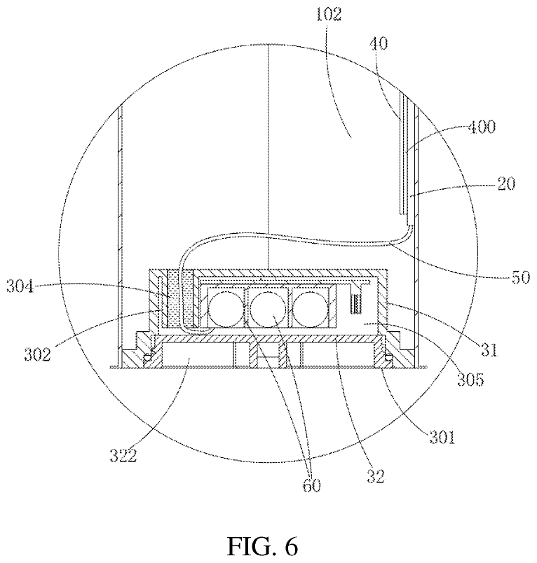

In some embodiments, as shown in FIGS. 3 and 6, the inflatable lighting device may further include a mounting cover 40, arranged in the inflatable cavity 100. A receiving cavity 400 may be formed between the mounting cover 40 and the inner wall 102 of the inflatable cavity 100. At least part of the illuminating body 20 may be received in the receiving cavity 400. The mounting cover 40 may be a sheet structure and may be arranged along the length direction of the cover 10, forming an elongated receiving cavity 400. After the illuminating body 20 is received in the receiving cavity 400, the illuminating body 20 may be clamped by the inner wall 102 of the inflatable cavity 100 and the mounting cover 40, and therefore, the illuminating body 20 may not be displaced easily. In order to enable the illuminating body 20 to be arranged in a more secured manner, adhesive may be used to stick the illuminating body 20 to the inner wall 102 of the inflatable cavity 100 or to the mounting cover 40. Specifically, the mounting cover 40 may be connected to the inner wall 102 of the inflatable cavity 100 by hot-pressing or adhesive bonding.

In some embodiments, as shown in FIGS. 6, 9, and 10, the inflatable lighting device may further include an electrical connection component 50, and the electrical connection component 50 may be electrically connected to the illuminating body 20 by a wire. The electrical connection component 50 may be a power wire or a contact connector (such as a pogo pin connector). When the illuminating body 20 is configured as a light panel 202 and a connection wire 203 in combination, the electrical connection component 50 may be connected to the connection wire 203. Furthermore, the electrical connection component 50 may penetrate the support member 30, and the electrical connection component 50 may be sealingly connected to the support member 30, preventing gas in the inflatable cavity 100 from leaking at a connection between the electrical connection component 50 and the support member 30. The electrical connection component 50 may be connected to an external power source or to an internal power source.

Specifically, the electrical connection component 50 may be configured as a power wire. A connection portion 302 may be arranged on the support member 30, and a wire hole 303 may be defined in the connection portion 302. The wire hole 303 may be communicated with the inflatable cavity 100. The electrical connection component 50 may pass through the wire hole 303 to be connected to the external power source or the internal power source. A sealing adhesive 304 may be filled in the wire hole 303, as shown in FIG. 6, preventing the inflatable cavity 100 from being communicated with an outside through the wire hole 303.

In some embodiments, the inflatable lighting device may be arranged with the internal power source. Specifically, the inflatable lighting device may further include a power supply component 60, a power supply cavity 305 may be defined in the support member 30, and the power supply component 60 may be mounted in the power supply cavity 305. The wire hole 303 may communicate the inflatable cavity 100 with the power supply cavity 305, and the electrical connection component 50 may electrically connect the illuminating body 20 to the power supply component 60.

In some embodiments, the power supply component 60 may be a battery compartment in which a storage battery may be mounted therein. Correspondingly, the support member 30 may include a housing 31 and a lid 32. The power supply cavity 305 and the wire hole 303 may be defined in the housing 31, and an opening 311 of the power supply cavity 305 may be defined on a bottom surface of the housing 31. The lid 32 may be mounted at the opening 311, and the lid 32 may seal the power supply cavity 305. In some embodiments, the lid 32 may be detachably mounted to the housing 31. Specifically, the lid 32 may be arranged with external threads, and the housing 31 may be arranged with internal threads at the opening 311. The lid 32 and the housing 31 may be connected to each other by threading, and a sealing ring may be arranged between the lid 32 and the housing 31, so as to improve sealing performance of the power supply cavity 305.

In some embodiments, the bottom surface 321 of the lid 32 may serve as the support surface 301, and a recessed groove 322 may be defined on the bottom surface 321 of the lid 32. A finger of the user may be received in the recessed groove 322 to rotate the lid 32. In other embodiments, the handle portion 34 may be arranged on the lid 32, and by rotating the handle portion 34, the opening 311 of the power supply cavity 305 may be opened. The bottom surface of the handle portion 34 may serve as the support surface 301.

In some embodiments, as shown in FIG. 14, a part of the support member 30 disposed outside the cover 10 may form the lower support member 33. The lower support member 33 may be integrally formed on the lid 32 or the housing 31.

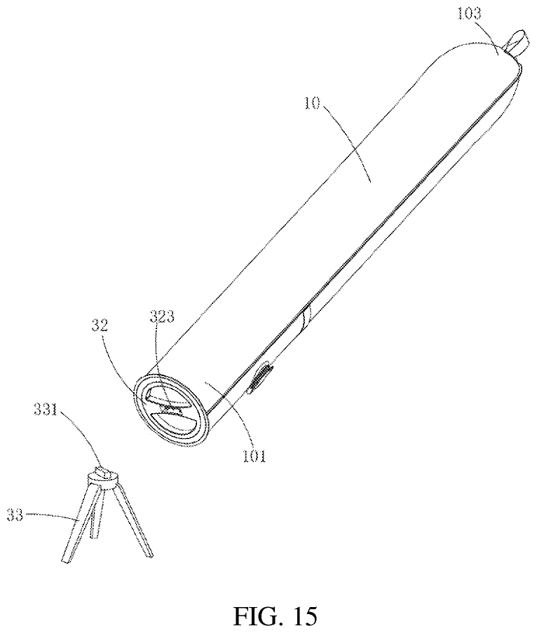

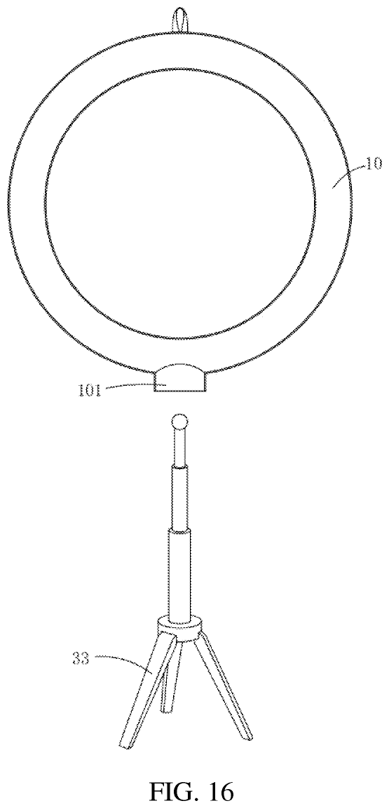

In some embodiments, as shown in FIG. 15, the support member 30 may further include the lower support member 33 independent from the lid 32. The lower support member 33 may be a tripod, and the tripod may be detachably connected to the lid 32. Specifically, an insertion slot 323 may be defined on the bottom surface 321 of the lid 32, and an insertion protrusion 331 may be arranged on a top of the tripod. The insertion protrusion 331 may be inserted into the insertion slot 323 to mount the tripod. In other embodiments, a threaded post may be arranged on the top of the tripod, and a threaded hole may be defined in the lid 32. The tripod may be mounted to the lid 32 via the threaded post. The other embodiment is not shown in the drawings. Further, as shown in FIG. 16, the top of the lower support member 33 may be used in combination with an extendable and retractable rod member or a rotation member, such that a height or an angle of the inflatable lighting device may be adjusted.

In some embodiments, in addition to be used by being placed on the placement surface such as the ground or the table top, the inflatable lighting device may be used by being hung on an object by other means. That is, the cover 10 may be arranged with a hanging assembly, the hanging assembly may hang the cover 10 on a wall, a ceiling, or any other position.

Specifically, as shown in FIG. 1, the mounting assembly may include at least one of a hanging element 70, a strap 80, and a magnetic attraction member 90.

The hanging element 70 may be arranged on the opposite end and may be hung on a hook that is pre-mounted on the wall/ceiling, or on an elongated object such as a tree branch, a handle, and so on.

Two ends of the strap 80 may be fixed to the cover 10, and the strap 80 may be attached to a side wall of the cover 10. The strap 80 may be arranged perpendicular to the length direction of the cover 10, such that a plate-shaped object of a suitable size may be inserted between the strap 80 and the cover 10. The strap 80 may be used to hang the inflatable lighting device on the plate-shaped object, such that a lighting direction of the inflatable lighting device may be the same as a facing direction of a plate surface of the plate-shaped object.

The magnetic attraction member 90 may be mounted on the cover 10 and may be configured to enable the inflatable lighting device to be attracted to the ferrous object, such as on an iron door, an iron railing, and so on. Specifically, at least two magnetic attraction members 90 may be arranged and may be distributed along the length direction of the cover 10, such that an angle at which the inflatable lighting device is fixed may be adjusted. Furthermore, the magnetic attraction members 90 may be disposed near the illuminating body 20. Therefore, by positioning the two magnetic attraction members 90, the illuminating body 20 may be positioned, and the illuminating body 20 may be adjusted more easily. Alternatively, the magnetic attraction member 90 may be mounted on the support member 30 to form the aforementioned magnetic component. Alternatively, the magnetic attraction member 90 and the aforementioned magnetic component may be arranged independently from each other.

According to the present disclosure, the support member may be arranged to support the cover on the placement surface such as the ground or the table top, allowing the inflatable lighting device to be used in an upright position.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and sub-combinations are of utility and may be employed without reference to other features and sub-combinations and are contemplated within the scope of the claims. Unless indicated otherwise, not all steps listed in the various figures need to be carried out in the specific order described

What is claimed is:

1. An inflatable lighting device, comprising:
a cover, defining an inflatable cavity therein, wherein gas is capable of being inflated into or deflated out of the inflatable cavity, and the cover has a placement end;
an illuminating body, being foldable and mounted in the inflatable cavity; and
a support member, mounted on the placement end of the cover and configured to support the cover.

2. The inflatable lighting device according to claim 1, wherein at least a part of the support member is received in the inflatable cavity, and the support member is sealingly connected to the cover.

3. The inflatable lighting device according to claim 1, wherein when the support member abuts against a placement surface, a vertical projection of a gravitational center of the inflatable lighting device onto a placement surface falls within a vertical projection of the support member onto the placement surface.

4. The inflatable lighting device according to claim 1, wherein the illuminating body is a flexible light strip.

5. The inflatable lighting device according to claim 1, wherein the illuminating body comprises a plurality of light panels, the plurality of light panels are flexibly connected to each other, and any one of the plurality of light panels is capable of being flipped with respect to an adjacent one of the plurality of light panels.

6. The inflatable lighting device according to claim 1, wherein a surface of the support member facing away from the cover is a support surface, and the support surface is a flat surface.

7. The inflatable lighting device according to claim 1, further comprising a mounting cover, wherein the mounting cover is received in the inflatable cavity, a receiving cavity is formed between the mounting cover and an inner wall of the inflatable cavity, and at least a part of the illuminating body is received in the receiving cavity.

8. The inflatable lighting device according to claim 7, wherein the mounting cover is connected to the inner wall of the inflatable cavity by heat-pressing or adhesive bonding.

9. The inflatable lighting device according to claim 1, further comprising an electrical connection component, wherein the electrical connection component is electrically connected to the illuminating body by a wire, the electrical connection component penetrates the support member, and the electrical connection component is sealingly connected to the support member.

10. The inflatable lighting device according to claim 9, wherein the support member is arranged with a connection portion, the connection portion defines a wire hole, the wire hole is communicated with the inflatable cavity, the electrical connection component passes through the wire hole, and a sealing adhesive is filled in the wire hole.

11. The inflatable lighting device according to claim 10, further comprising a power supply component, wherein:
a power supply cavity is defined in the support member, and the power supply component is mounted in the power supply cavity; and
the wire hole communicates the inflatable cavity with the power supply cavity, and the electrical connection component electrically connects the illuminating body with the power supply component.

12. The inflatable lighting device according to claim 11, wherein the support member comprises a housing and a lid, the power supply cavity and the wire hole are both defined in the housing, and an opening of the power supply cavity is defined in the housing, the lid is mounted at the opening, and the lid is configured to seal the power supply cavity.

13. The inflatable lighting device according to claim 12, wherein the lid and the housing are detachably connected to each other.

14. The inflatable lighting device according to claim 13, wherein a bottom surface of the lid defines a recessed groove.

15. The inflatable lighting device according to claim 1, further comprising a hanging element, wherein the hanging element is arranged on the cover.

16. The inflatable lighting device according to claim 1, further comprising a strap, wherein two ends of the strap are fixed on the cover.

17. The inflatable lighting device according to claim 1, further comprising a magnetic attraction member, wherein the magnetic attraction member is mounted on the cover and disposed near the illuminating body.
